(19) United States
(12) Patent Application Publication
(10) Pub. No.: US 2023/0184867 A1
(43) Pub. Date: Jun. 15, 2023

(54) RECONFIGURABLE AIRWAY SIGNALING SYSTEM

(71) Applicant: OWLYNK CO., LTD., Seongnam-si, Gyeonggi-do (KR)

(72) Inventor: Shin Hwan HWANG, Yongin-si (KR)

(73) Assignee: OWLYNK CO., LTD., Seongnam-si, Gyeonggi-do (KR)

(21) Appl. No.: 18/077,245

(22) Filed: Dec. 8, 2022

(30) Foreign Application Priority Data
Dec. 9, 2021 (KR) 10-2021-0175344

(51) Int. Cl. G01S 3/46; G08G 5/02

(52) U.S. Cl. CPC G01S 3/46; G08G 5/025; B64C 39/024

(57) ABSTRACT

Provided are an airway setting device for signaling an airway to an aerial vehicle and an automatic navigation system for controlling the aerial vehicle to fly the airway. The airway setting device transmits radio frequency (RF) signals through two antennas spaced apart from each other. The transmitted RF signals are encoded with phase difference information intended for an aerial vehicle receiving the transmitted RF signals. An automatic navigation system of the aerial vehicle receives the RF signals from the two antennas spaced apart from each other, measures a phase difference between the RF signals, decodes encoded phase difference information, and compares the measured phase difference with the decoded phase difference to identify and maintain an airway.

### CROSS-REFERENCE TO RELATED APPLICATION(S)

This application claims priority from Korean Patent Application No. 10-2021-0175344, filed on Dec. 9, 2021, in the Korean Intellectual Property Office, the disclosure of which is incorporated herein by reference in its entirety.

### BACKGROUND

### 1. Field

The following description relates to an airway setting system for signaling an airway to an aerial vehicle and an automatic navigation system for controlling the aerial vehicle to fly the airway.

### 2. Description of Related Art

Existing airplanes maintain their course based on a global positioning system (GPS). In the case of urban air mobility (UAM) that is being discussed as a means of transportation in the future, there is a risk of collision due to a dramatic increase in the number of aerial vehicles in operation and thus there is a need for an airway similar to a road. However, technology for setting an airway has not yet been presented.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description is directed to setting an airway to allow an aerial vehicle in operation to identify the airway.

The following description is also directed to providing a technique for setting an airway for aerial vehicles to use the airway in a manner similar to driving on a road.

The following description is also directed to providing a technique for setting and signaling an airway to be used by many aerial vehicles at relatively low infrastructure costs.

In a general aspect, an airway setting device transmits radio frequency (RF) signals through two antennas spaced apart from each other. The transmitted RF signals are encoded with phase difference information intended for an aerial vehicle receiving the transmitted RF signals. An automatic navigation system of the aerial vehicle receives the RF signals from the two antennas spaced apart from each other, measures a phase difference between the RF signals, decodes the encoded phase difference information, and compares the measured phase difference with the decoded phase difference to identify and maintain an airway.

According to an additional aspect, the airway setting device may respond to only a receiver whose measured phase difference and decoded phase difference information match, establish a session with the receiver, and control an aerial vehicle equipped with the receiver through the session.

According to an additional aspect, the airway setting device may set an airway in not only a horizontal direction but also a vertical direction. To this end, the airway setting device may provide phase difference information in the horizontal direction and phase difference information in the vertical direction.

According to an additional aspect, the airway setting device may control an orientation of an antenna to set an airway variously without communication with an aerial vehicle.

Other features and aspects will be apparent from the following detailed description, the accompanying drawings, and the claims.

### BRIEF DESCRIPTION OF THE DRAWINGS

FIG. 1 illustrates an airway setting device and an aerial vehicle according to an embodiment.

FIG. 2 is a diagram for describing a radio frequency (RF) signal transmitted through an antenna employed in the present disclosure.

FIG. 3 is a block diagram illustrating a configuration of an airway setting device according to an embodiment.

FIG. 4 schematically illustrates some RF signals in an airway setting system to which an airway setting device according to an embodiment is applied.

FIG. 5 is a block diagram illustrating a configuration of an airway setting device according to another embodiment.

FIG. 6 schematically illustrates an RF signal transmitted from an airway setting device according to the embodiment of FIG. 5.

FIG. 7 is a block diagram illustrating a configuration of an airway setting device according to another embodiment.

FIG. 8 is a block diagram illustrating a configuration of an airway setting device according to another embodiment.

FIG. 9 schematically illustrates an RF signal transmitted by an airway setting device according to the embodiment of FIG. 8.

FIG. 10 is a block diagram illustrating a configuration of an automatic navigation system according to an embodiment.

FIG. 11 is a block diagram illustrating a configuration of an automatic navigation system according to another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and additional aspects will be implemented through embodiments described with reference to the accompanying drawings. It should be understood that components of each embodiment can be implemented in various combinations therein or with those of other embodiments, unless mentioned otherwise and as long as there is no contradiction between components. The terms used in the present specification and the claims should be interpreted as meanings and concepts in accordance with the description herein or the proposed technical idea, based on the principle that the inventors can appropriately define the concept of the terms to describe the present disclosure in the best way. Hereinafter, embodiments of the present disclosure will be described in detail with reference to the accompanying drawings.

In an aspect, an airway setting device transmits radio frequency (RF) signals through two antennas spaced apart from each other. Phase difference information intended for an aerial vehicle receiving the transmitted RF signals is encoded in the transmitted RF signals. An automatic navigation system of the aerial vehicle receives the RF signals from the two antennas spaced apart from each other, measures a phase difference between the RF signals, decodes encoded phase difference information, and compares the decoded phase difference with the measured phase difference to identify and maintain an airway.

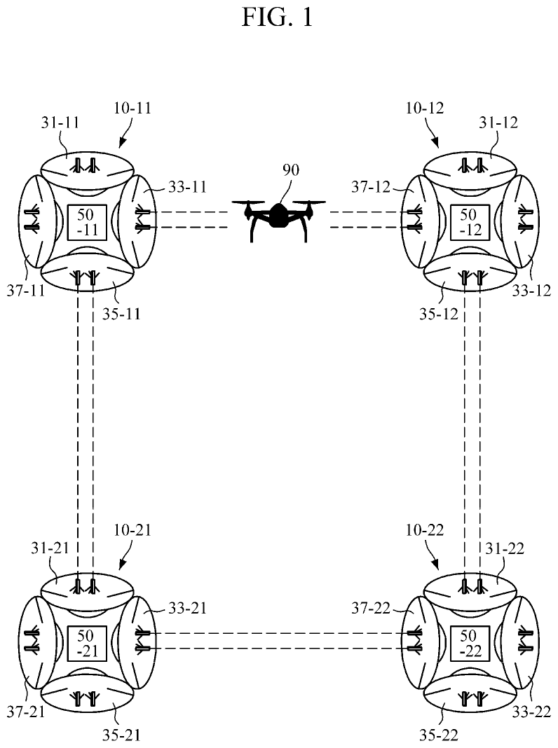

FIG. 1 illustrates an airway setting device and an aerial vehicle according to an embodiment. An airway setting device 10 according to the embodiment includes four reflectors 31, 33, 35, and 37 assembled adjacent to each other in all directions and each being fixed with two antennas spaced apart from each other, and a wireless transmission circuit 50 that supplies RF signals to the reflectors 31, 33, 35, and 37. In an example shown here, airway setting devices 10-11, 10-12, 10-21, and 10-22 are arranged in a two-dimensional (2D) array. However, the present disclosure is not limited thereto, and airway setting devices may be configured to include only two-way or three-way reflectors or only five-way reflectors. Such airway setting devices may be installed on a spire or outer wall of a building.

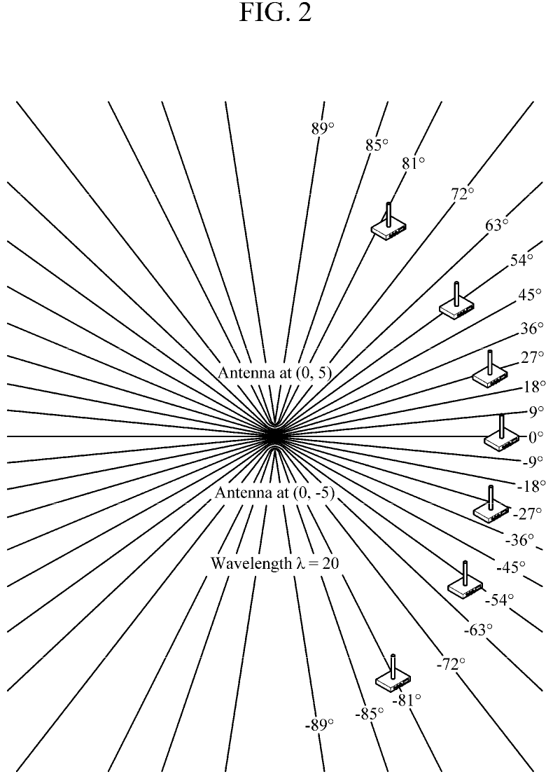

FIG. 2 is a diagram for describing an RF signal transmitted through an antenna employed in the present disclosure. RF signals transmitted through at least two omni-directional antennas spaced a certain distance from each other include transmission direction information. In an embodiment, the transmission direction information is phase difference information of a receiver that will receive the transmitted RF signals. The receiver receives the RF signals and decodes the phase difference information. Meanwhile, the receiver measures a phase difference between two RF signals received from two omni-directional antennas. The receiver determines that a transmitter has accessed desired communication when a result of comparing the measured phase difference with the decoded phase difference information reveals that they are the same. As illustrated in FIG. 2, a trajectory with the same phase difference with respect to two antennas spaced apart from each other forms a hyperbola. That is, phase differences measured by two receivers on the hyperbola have the same value. As shown in FIG. 2, hyperbolas are arranged according to a direction, i.e., an angle, based on a transmission axis, which is a symmetrical axis of the two antennas, based on the phase difference. That is, the receiver may identify a direction on the basis of a transmission axis by measuring a phase difference. A directional communication method using such an omni-directional antenna is disclosed in Korean Patent Application No. 2021-0125699 filed by the present applicant on Sep. 23, 2021.

In this method, a transmitter does not necessarily have to transmit an RF signal, which includes encoded information about a phase difference, only in a direction corresponding to the phase difference. Even when the transmitter transmits RF signals in all directions, the receiver may measure a phase difference and selectively respond to an instantaneous RF signal containing phase difference information corresponding to the measured phase difference, thereby achieving the directionality of communication. To distinguish between RF signals transmitted through at least two omni-directional antennas spaced a certain distance from each other, the transmitter may sequentially transmit RF signals through the at least two antennas. As another example, the transmitter may change a carrier frequency for modulation of RF signals transmitted through the at least two antennas. In addition, the transmitter may sequentially transmit an RF signal encoded with N phase difference values, e.g., 20 phase difference values, as transmission direction information within a certain set range, e.g., a range of 25 degrees to −25 degrees. Generally, when only one aerial vehicle flies an airway, the aerial vehicle may select and fly an airway corresponding to a phase difference of 0 degrees. When two aerial vehicles fly an airway, a control center may control automatic navigation systems of the aerial vehicles to select different phase differences according to a distance from an antenna to avoid a collision. An airway setting device may respond to only a receiver whose measured phase difference and decoded phase difference information match, establish a session, and communicate with the receiver through the session to control an aerial vehicle.

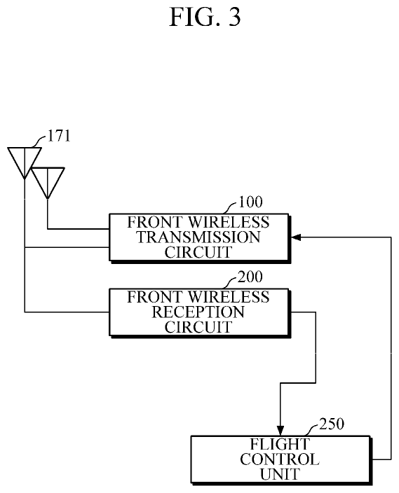

FIG. 3 is a block diagram illustrating a configuration of an airway setting device according to an embodiment. As shown in FIG. 3, an airway setting device according to the embodiment includes front antennas 171 and a front wireless transmission circuit 100. The front antennas 171 are arranged along an airway in one direction and each include at least two antennas spaced apart from each other to transmit an RF signal. In the illustrated embodiment illustrated, the front antennas 171 include only two antennas 171. Each of the front wireless transmission circuits 100 is provided for one of the front antennas 171, encodes transmission direction information based on a transmission axis of the corresponding front antenna 171, generates an RF signal separate from an RF signal received through an adjacent front antenna 171, and supplies the generated RF signal to the corresponding front antenna 171. As described above, in the above method, at least two antennas among front antennas are omni-directional transmission antennas, and front wireless transmission circuits may sequentially apply an RF signal encoded with N pieces of transmission direction information, to front antennas corresponding thereto within a set range based on a transmission axis.

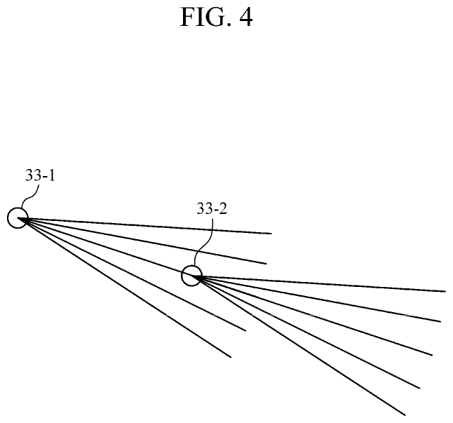

FIG. 4 schematically illustrates some RF signals in an airway setting system to which an airway setting device according to an embodiment is applied. The airway setting system includes two airway setting devices 33-1 and 33-2. The airway setting device 33-2 is installed within the reach of an RF signal transmitted from the airway setting device 33-1. Although only the two airway setting devices 33-1 and 33-2 are shown in the illustrated example, it will be obvious that a long or curved airway may be set by consecutively arranging more than two airways.

Referring back to FIG. 3, the front wireless transmission circuit 100 may employ a time division method or a frequency division method to separate an RF signal, which is to be transmitted, from an RF signal from an adjacent front antenna. For example, an RF signal transmitted from the airway setting device 33-1 should be distinguished from an RF signal transmitted from the airway setting device 33-2 adjacent thereto. In the time division method, front wireless transmission circuits connected to adjacent front antennas supply RF signals at different times. To this end, the front wireless transmission circuits may each include a synchronization circuit. For example, the synchronization circuit may receive a synchronization signal from a clock master and synchronize an internal clock with the synchronization signal. Each front wireless transmission circuit may be set by allocating an RF signal transmission slot thereto when installed to avoid interference between adjacent airway setting devices.

In the frequency division method, front wireless transmission circuits connected to adjacent front antennas apply RF signals modulated at different frequencies. To this end, the front wireless transmission circuits may each include a frequency modulation circuit. When each front wireless transmission circuit is installed, a variable oscillator of a modulation circuit may be set by allocating a frequency band of a carrier wave to avoid interference between adjacent airway setting devices.

In an additional aspect, an airway setting device may respond to only a receiver whose measured phase difference and decoded phase difference information match, establish a session with the receiver, and control an aerial vehicle equipped with the receiver through the session. In the illustrated embodiment, the airway setting device may further include a flight control unit 250. The flight control unit 250 establishes a session with a receiver whose measured transmission direction information and decoded transmission direction information match, and controls an aerial vehicle equipped with the receiver through the session. Although the airway setting device transmits an RF signal encoded with the transmission direction information in all directions, the receiver installed in the aerial vehicle may receive RF signals through two antennas and measure a phase difference between the received RF signals to obtain information about a direction thereof, i.e., transmission direction information, based on a transmission axis of the two antennas, and respond to a received RF signal whose obtained transmission direction information and decoded transmission direction information match to establish a session with the airway setting device. The airway setting device includes a front wireless reception circuit 200. In the illustrated embodiment, the front wireless transmission circuit 100 includes two transmission circuits for two respective antennas but only one front wireless transmission circuit is connected to only one antenna 171. Through the set session, the airway setting device may individualize an airway for each aerial vehicle to fly in a different direction, so that control may be performed for collision avoidance between aerial vehicles.

According to an additional aspect, the airway setting device may set an airway not only in a horizontal direction but also a vertical direction. To this end, the airway setting device may provide phase difference information in the horizontal direction and phase difference information in the vertical direction.

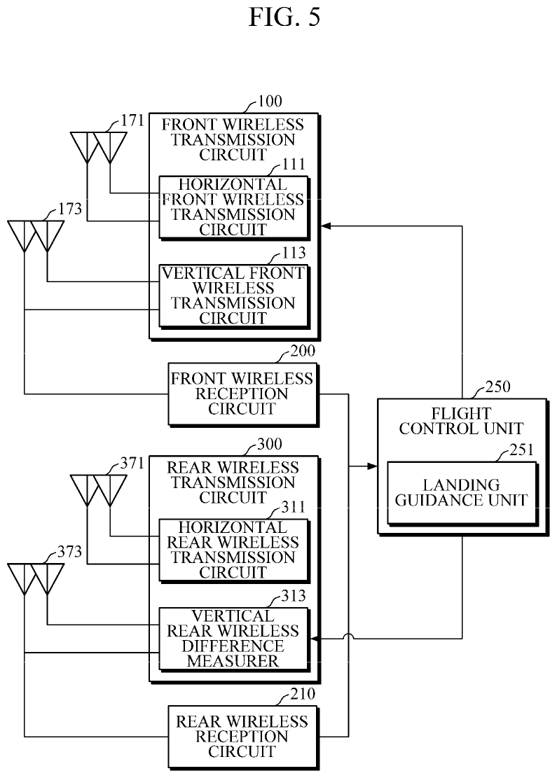

FIG. 5 is a block diagram illustrating a configuration of an airway setting device according to another embodiment. In the illustrated embodiment, a front antenna includes a horizontal front antenna 171 and a vertical front antenna 173. The horizontal front antenna 171 is disposed along an airway in one direction and includes at least two antennas spaced apart from each other in a direction parallel to the ground. The vertical front antenna 173 includes at least two antennas having the same transmission axis as the horizontal front antenna 171 and spaced apart from each other in a direction perpendicular to the ground.

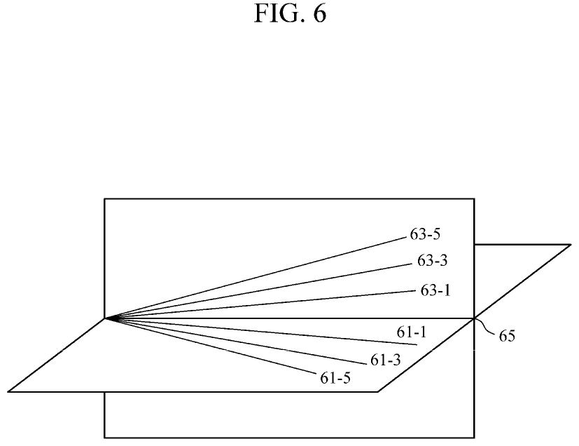

FIG. 6 schematically illustrates an RF signal transmitted from an airway setting device according to the embodiment of FIG. 5. Transmission beams 61-1, 61-3, and 61-5 represent an RF signal transmitted in the horizontal direction through a horizontal front antenna 171. In FIG. 6, only some transmission beams of an RF signal transmitted through the horizontal front antenna 171 are illustrated on a horizontal plane, but the RF signal is transmitted through the horizontal front antenna 171 in all directions. Transmission beams 63-1, 63-3, and 63-5 represent an RF signal transmitted through the vertical front antenna 173 in the vertical direction. A transmission axis 65 is shared by a horizontal RF signal and a vertical RF signal. In FIG. 6, only some transmission beams of an RF signal transmitted through the vertical front antenna 173 are illustrated on a vertical plane, but the RF signal is transmitted through the vertical front antenna 173 in all directions. In an RF signal transmitted in all directions through the horizontal front antenna 171, a trajectory of a position of a receiver with the same phase difference as a phase difference measured by the receiver with respect to two horizontal front antennas 171 is a plane with a hyperbolic surface. Similarly, in an RF signal transmitted in all directions through the vertical front antenna 173, a trajectory of a position of the receiver with the same phase difference as a phase difference measured by the receiver with respect to two vertical front antennas 173 is a plane with a hyperbolic surface. The receiver may measure phase differences in the vertical and horizontal directions and identify a position thereof in a three-dimensional (3D) direction based on a transmission axis defined by a hyperbola of intersections of the measured phase differences.

In the embodiment of FIG. 5, the front wireless transmission circuit 100 includes a horizontal front wireless transmission circuit 111 and a vertical front wireless transmission circuit 113. The horizontal front wireless transmission circuit 111 generates an RF signal encoded with transmission direction information in the direction parallel to a transmission axis and separated from RF signals transmitted through adjacent horizontal and vertical front antennas, and supplies the generated RF signal to the horizontal front antenna 171 corresponding thereto. The time division method or the frequency division method may be employed to separate the RF signal from the RF signals transmitted through the adjacent horizontal and vertical front antennas. In the time division method, horizontal front wireless transmission circuits connected to an adjacent horizontal front antenna supply RF signals at different times. To this end, the front wireless transmission circuits may each include a synchronization circuit. For example, the synchronization circuit may receive a synchronization signal from a clock master and synchronize an internal clock with the synchronization signal. Each horizontal front wireless transmission circuit and each vertical front wireless transmission circuit may be set by allocating an RF signal transmission slot thereto when installed to avoid interference between adjacent airway setting devices.

In the frequency division method, horizontal front wireless transmission circuits and vertical front wireless transmission circuits connected to an adjacent horizontal front antenna supply RF signals modulated at different times. To this end, the front wireless transmission circuits may each include a frequency modulation circuit. When each front wireless transmission circuit is installed, a variable oscillator of a modulation circuit may be set by allocating a frequency band of a carrier wave to avoid interference between adjacent airway setting devices.

The vertical front wireless transmission circuit 113 generates an RF signal encoded with transmission direction information in the direction perpendicular to a transmission axis and separated from RF signals transmitted through adjacent horizontal and vertical front antennas, and supplies the generated RF signal to the vertical front antenna 173 corresponding thereto. The time division method or the frequency division method may be employed to separate the RF signal from the RF signals transmitted through the adjacent horizontal and vertical front antennas. The time division method or the frequency division method has been described above with respect to the horizontal front wireless transmission circuit 111 and thus a detailed description will be omitted here.

An aerial vehicle may identify a 3D angular position by identifying an angular position in the vertical direction on the basis of phase differences in not only the horizontal direction but also the vertical direction. Accordingly, a 3D airway may be set.

An aerial vehicle that maintains its course using an RF signal from a front antenna and an RF signal from a rear antenna will be described with reference to FIG. 1 below. An RF signal with phase difference information is emitted from the right reflector 33-11 of the airway setting device 10-11 in all directions through two antennas spaced apart from each other. In addition, an RF signal with phase difference information is emitted from the left reflector 33-12 of the airway setting device 10-12 in all directions through two antennas spaced apart from each other. An aerial vehicle 90 includes a receiver therein. The receiver measures a phase difference between RF signals received through the two antennas of the right reflector 33-11, and decodes phase difference information encoded in the RF signals. Additionally, the receiver measures a phase difference between RF signals received through the two antennas of the left reflector 33-12, and decodes phase difference information encoded in the RF signals. The aerial vehicle 90 may maintain a target airway by calculating a direction on the basis of a phase difference from the airway setting device 10-11, calculating a direction on the basis of a phase difference from the airway setting device 10-12, and identifying an angular position from two points based on the calculated directions.

Referring back to FIG. 5, as described above, at least two antennas of each of the front antennas 171 and 173 may be configured as omni-directional transmission antennas. In this case, the front wireless transmission circuit 100 sequentially supplies an RF signal encoded with N pieces of transmission direction information to corresponding front antennas 171 and 173 within a set range based on a transmission axis, as described above.

In the illustrated embodiment, each airway setting device may further include rear antennas 371 and 373 and rear wireless transmission circuits 300. The rear antennas 371 and 373 are disposed behind the front antennas 171 and 173 in a direction opposite to the direction in which the front antennas 171 and 173 are disposed, and each includes at least two antennas that are spaced apart from each other to transmit an RF signal. For example, in FIG. 1, the rear antenna 37-11 is disposed behind the front antenna 33-11 in a left direction opposite a right direction toward which the front antenna 33-11 faces. Each of the rear wireless transmission circuits 300 is provided for one rear antenna, encodes transmission direction information based on a transmission axis of the rear antenna, generates an RF signal separate from RF signals from adjacent front and rear antennas, and supplies the generated RF signal to a corresponding rear antenna. The rear antennas 371 and 373 are the same as the front antennas 171 and 173 and the rear wireless transmission circuit 300 is the same as the front wireless transmission circuit 100 in terms of functions thereof, and thus, a detailed description thereof will be omitted here.

As described above, at least two antennas of each of the rear antennas 371 and 373 may be configured as omni-directional transmission antennas. In this case, the rear wireless transmission circuit 300 sequentially supplies an RF signal encoded with N pieces of transmission direction information to corresponding rear antennas 371 and 373 within a set range based on a transmission axis, as described above.

In an additional aspect, an airway setting device may respond to only a receiver whose measured phase difference and decoded phase difference information match, establish a session with the receiver, and control an aerial vehicle equipped with the receiver through the session. In the embodiment of FIG. 5, the airway setting device may further include a flight control unit 250. The flight control unit 250 establishes a session with a receiver whose measured transmission direction information and decoded transmission direction information match, and controls an aerial vehicle equipped with the receiver through the session. Although the airway setting device transmits an RF signal encoded with the transmission direction information in all directions, the receiver installed in the aerial vehicle may receive RF signals transmitted through two antennas and measure a phase difference between the received RF signals to obtain information about a direction thereof, i.e., the transmission direction information, based on a transmission axis of the two antennas, and respond to a received RF signal whose obtained transmission direction information and decoded transmission direction information match to establish a session with the airway setting device. The airway setting device includes a front wireless reception circuit 200 and a rear wireless reception circuit 210. In the illustrated embodiment, forward transmission is performed by four transmission circuits connected to two antennas of the horizontal front wireless transmission circuit 111 and two antennas of the vertical front wireless transmission circuit 113, whereas only one front wireless transmission circuit 200 is connected to only one antenna 173. Encoded information does not need to be different for the horizontal front antenna 171 and the vertical front antenna 173.

Similarly, in the illustrated embodiment, rearward transmission is performed by four transmission circuits connected to two antennas of a horizontal rear wireless transmission circuit 311 and two antennas of a vertical rear wireless transmission circuit 313, whereas only one front wireless transmission circuit 210 is connected to only one antenna 373. Encoded information does not need to be different for the horizontal rear antenna 371 and the vertical rear antenna 373. Through the set session, the airway setting device may individualize an airway for each aerial vehicle to fly in a different direction, so that control may be performed for collision avoidance between aerial vehicles

As another example, the airway setting device may guide an aerial vehicle, which requests to land through a session connected to the receiver, to fly toward a landing site. When the landing site is assigned, a virtual airway to the landing site is set and information about the airway is provided to the aerial vehicle to enter the airway. The aerial vehicle can be guided along the airway to land by controlling the flight thereof such that transmission direction information measured from RF signals received by the receiver matches transmission direction information of the received information about the airway.

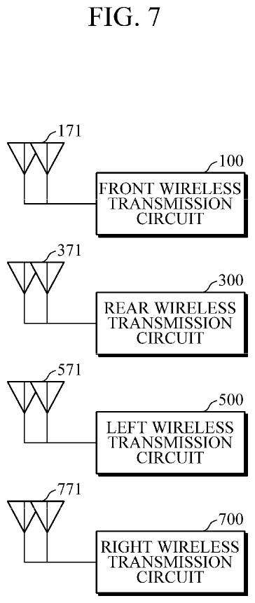

FIG. 7 is a block diagram illustrating a configuration of an airway setting device according to another embodiment. In the illustrated embodiment, each airway setting device may further include left antennas 571 and left wireless transmission circuits 500. Each of the left antennas 571 is disposed on the left side of one of front antennas 171 and includes at least two antennas spaced apart from each other to transmit an RF signal. For example, in FIG. 7, the left antenna 571 is disposed on the left side of the front antenna 171 in the left direction with respect to a direction toward which the front antenna 171 faces. Each of the left wireless transmission circuits 500 is provided for one of the left antennas 571, encodes transmission direction information based on a transmission axis of the corresponding left antenna 571, generates an RF signal separate from RF signals transmitted through adjacent antennas, and supplies the generated RF signal to the corresponding left antenna 571. The left antenna 571 and the left wireless transmission circuit 500 are respectively the same as the front antenna 171 and the front wireless transmission circuit 100 in terms of functions thereof, and thus, a detailed description thereof will be omitted here.

In the illustrated embodiment, each airway setting device may further include right antennas 771 and right wireless transmission circuits 700. Each of the right antennas 771 is disposed on the right side of one of the front antennas 171 and includes at least two antennas spaced apart from each other to transmit an RF signal. For example, in FIG. 7, the right antenna 771 is disposed on the right side of the front antenna 171 in the right direction with respect to the direction toward which the front antenna 171 faces. Each of the right wireless transmission circuits 700 is provided for one of the right antennas 771, encodes transmission direction information based on a transmission axis of the corresponding right antenna 771, generates an RF signal separate from RF signals transmitted through adjacent antennas, and supplies the generated RF signal to the corresponding right antenna 771. The right antenna 771 and the right wireless transmission circuit 700 are respectively the same as the front antenna 171 and the front wireless transmission circuit 100 in terms of functions thereof, and thus, a detailed description thereof will be omitted here.

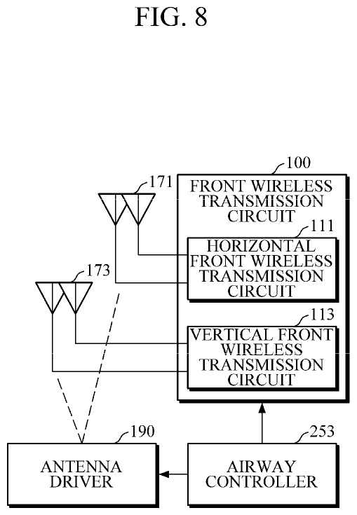

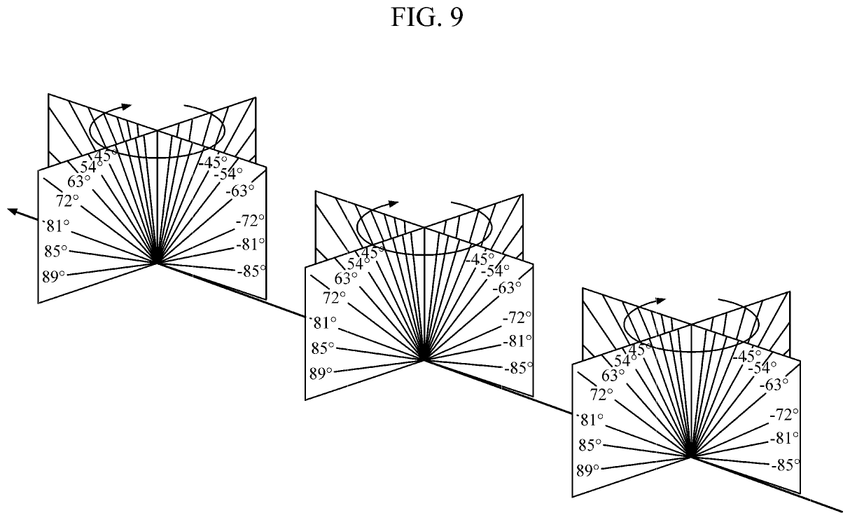

According to an additional aspect, an airway setting device may control an orientation of an antenna to set an airway more diversely without communication with an aerial vehicle. FIG. 8 is a block diagram illustrating a configuration of an airway setting device according to another embodiment. In the illustrated embodiment, the airway setting device further includes an antenna driver 190 and an airway controller 253 as compared with the above-described embodiments. The antenna driver 190 is equipped with a front antenna and rotates about a rotational axis in response to a driving signal. The airway controller 253 controls the antenna driver 190 to change a transmission direction of the front antenna. FIG. 9 schematically illustrates an RF signal transmitted from an airway setting device according to the embodiment of FIG. 8. FIG. 9 illustrates an example in which a transmission direction of a horizontal front antenna is changed in an airway setting device that includes both the horizontal front antenna and a vertical front antenna. For example, the horizontal front antenna may be rotatably driven in a 45-degree direction to transmit an RF signal for setting an airway toward a subsequent airway setting device located in the 45-degree direction.

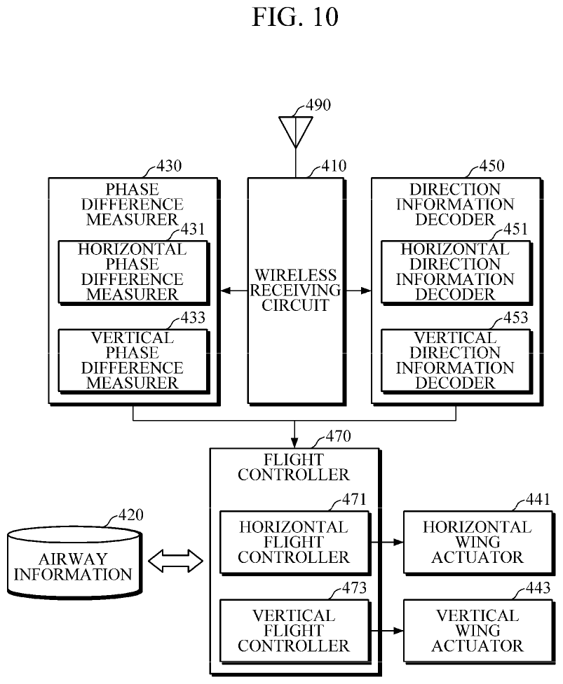

FIG. 10 is a block diagram illustrating a configuration of an automatic navigation system according to an embodiment. In an embodiment, the automatic navigation system includes a reception antenna 490, a wireless reception circuit 410, a phase difference measurer 430, a direction information decoder 450, and a flight controller 470.

The reception antenna 490 receives RF signals transmitted through at least two transmission antennas spaced apart from each other. The RF signals transmitted through the two transmission antennas may be distinguished from each other in terms of time or frequency. The wireless reception circuit 410 demodulates RF signals received through the reception antenna 490. The phase difference measurer 430 measures a phase difference between RF signals transmitted through the two transmission antennas spaced apart from each other from the RF signals received through the reception antenna 490. The phase difference may be measured from an intermediate frequency signal or a demodulated baseband signal. The direction information decoder 450 decodes transmission direction information included in an RF signal received through the reception antenna 490. In an embodiment, the transmission direction information may be obtained by cutting a corresponding information region of a base signal demodulated by the wireless reception circuit 410 and decoding the corresponding information region. In an embodiment, the transmission direction information is phase difference information.

The flight controller 470 identifies a current position thereof by reflecting a result of comparison between a phase difference measured by the phase difference measurer 430 and transmission direction information decoded by the direction information decoder 450, and controls a direction of flight according to a target airway stored in airway information 420. When a current airway section is included in the target airway and there are no other aerial vehicles in the current airway section, the flight controller 470 controls a direction of flight such that both the phase difference measured by the phase difference measurer 430 and the phase difference information decoded by the direction information decoder 450 are 0. That is, when a phase difference measured at a first position by the phase difference measurer 430 is different from phase difference information decoded by the direction information decoder 450, a process of comparing a phase difference measured at a second position by the phase difference measurer 430 with phase difference information decoded by the direction information decoder 450 is repeatedly performed several times to determine whether a difference between a phase difference and phase difference information is less than a previous difference and to change a direction of flight to reduce the difference or to maintain a current direction of flight. To avoid a collision with an aerial vehicle in the same airway section, the flight controller 470 may measure a phase difference from RF signals in which a non-zero phase difference value is decoded and control a direction of flight such that the measured phase difference value is the same as the decoded phase difference value.

In the illustrated embodiment, the phase difference measurer 430 may include a horizontal phase difference measurer 431 and a vertical phase difference measurer 433. The horizontal phase difference measurer 431 measures a phase difference between at least two horizontal RF signals in a direction parallel to the ground. The vertical phase difference measurer 433 measures a phase difference between at least two vertical RF signals in a direction perpendicular to the ground. In this case, a transmission antenna includes two antennas arranged horizontally with respect to the ground and two antennas arranged vertically with respect to the ground.

In the illustrated embodiment, the direction information decoder 450 includes a horizontal direction information decoder 451 and a vertical direction information decoder 453. The horizontal direction information decoder 451 decodes horizontal direction information included in a horizontal RF signal. The vertical direction information decoder 453 decodes vertical direction information included in a vertical RF signal. In an embodiment, horizontal transmission direction information and vertical transmission direction information may be obtained by cutting and decoding corresponding information regions of base signals demodulated by the wireless reception circuit 410. Each RF signal may be transmitted through a transmission antenna in a time division manner and sequentially demodulated and buffered by the wireless reception circuit 410. In an embodiment, the transmission direction information is phase difference information.

In the illustrated embodiment, the flight controller 470 includes a horizontal flight controller 471 and a vertical flight controller 473. The horizontal flight controller 471 controls horizontal flight by reflecting a result of comparison between a horizontal phase difference and horizontal direction information. Accordingly, an aerial vehicle may maintain an airway in the horizontal direction. The vertical flight controller 473 controls vertical flight by reflecting a result of comparison between a vertical phase difference and vertical direction information. Accordingly, the aerial vehicle may maintain the airway in the vertical direction.

The aerial vehicle controls a direction thereof by tilting horizontal and vertical tail wings thereof. The aerial vehicle may be controlled to turn left or right by tilting the vertical tail wings and controlled to ascend or descend by tilting the two horizontal tail wings in the same direction with respect to an axis of symmetry. By tilting the horizontal tail wings in opposite directions, the body of the aerial vehicle may be controlled to roll clockwise or counterclockwise.

The flight controller 470 may control flight such that a phase difference measured by the phase difference measurer 430 is the same as transmission direction information decoded by the direction information decoder 450, that is, the transmission direction information converges to a direction of a transmission axis. In general, the flight controller 470 may control flight based on a phase difference of 0 when there is no aerial vehicle in the same airway section. To avoid a collision with an aerial vehicle in the same airway section, the flight controller 470 may measure a phase difference from RF signals in which a non-zero phase difference value is decoded and control a direction of flight such that the measured phase difference value is the same as the decoded phase difference value.

All or some of the blocks illustrated in the embodiment of FIG. 10 may represent a functional group of program instructions stored in a memory and read and executed by a microprocessor. Technology for implementing such functions is possible in various combinations including circuits, a general-purpose processor, a signal processing processor, a dedicated semiconductor circuit, a semiconductor gate array, and the like and thus a detailed description will be omitted here.

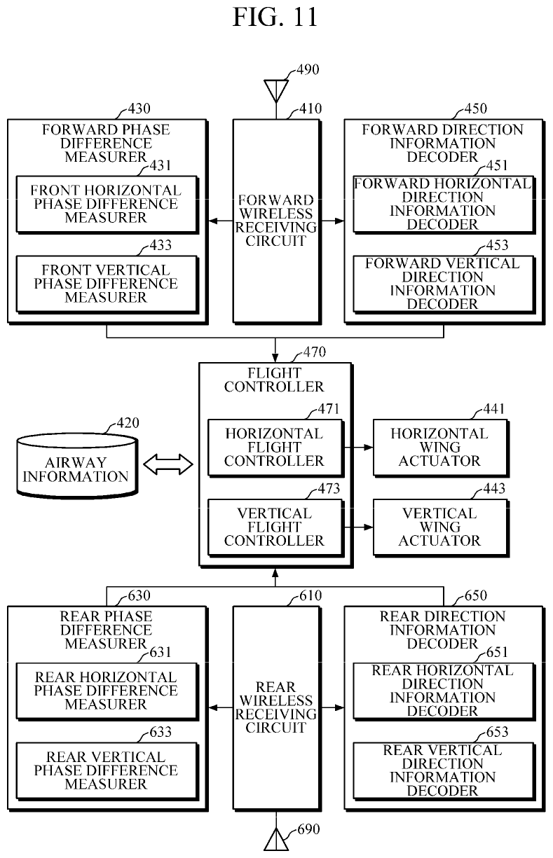

FIG. 11 is a block diagram illustrating a configuration of an automatic navigation system according to another embodiment. The illustrated embodiment is different from the embodiment of FIG. 10 in that a rear antenna 690, a rear wireless reception circuit 610, a rear phase difference measurer 630, and a rear direction information decoder 650 are further provided. These components are similar to the above-described forward components corresponding thereto except that these components are disposed are disposed to face the rear of an aerial vehicle. A flight controller 470 may perform flight control such that a phase difference measured by a forward phase difference measurer 430 and a phase difference measured by the rear phase difference measurer 630 may respectively match transmission direction information decoded by a forward direction information decoder 450 and transmission direction information decoded by the rear direction information decoder 650, i.e., the transmission direction information may converge to a direction of a transmission axis. In addition, a horizontal flight controller 471 may perform flight control in the horizontal direction by reflecting a result of comparison between a front horizontal phase difference and front horizontal direction information, as well as a result of comparison between a rear horizontal phase difference and rear horizontal direction information. Accordingly, an aerial vehicle may maintain an airway in the horizontal direction. Similarly, a vertical flight controller 473 may perform flight control in the vertical direction by reflecting a result of comparison between a front vertical phase difference and front vertical direction information, as well as a result of comparison between a rear vertical phase difference and rear vertical direction information. Accordingly, the aerial vehicle may maintain the airway in the vertical direction.

A vertical phase difference input to the vertical flight controller 473 may be obtained from antennas of an airway setting device facing forward or rearward as shown in FIG. 6 or obtained from antennas of an airway setting device facing upward as shown in FIG. 9.

In addition, the vertical flight controller 473 may compare a front vertical phase difference with a rear vertical phase difference to determine an altitude or determine whether a direction of flight is a forward or rearward direction. In other words, a phase difference measured in the front vertical direction and a phase difference measured in the rear vertical direction may be converted to an accurate vertical angular position using hyperbolic trajectories, and a current altitude of an aerial vehicle may be calculated from distances between airway setting devices because the distances between airway setting devices are known. It may be determined that the aerial vehicle is flying forward when the front vertical phase difference increases and the rear vertical phase difference decreases over time, and the aerial vehicle is flying rearward in an opposite case.

According to the present disclosure, airway setting technology that can be used by many aerial vehicles at relatively low infrastructure costs can be achieved. An airway is invisible to the human eye but is signaled by a receiver of an aerial vehicle so that the airway may be identified by an automatic navigation system. Generally, beacons are installed to be spaced apart from each other geographically and aerial vehicles can measure distances to the beacons and identify positions thereof using trigonometry. In this regard, the present disclosure can apply to a case in which many small aerial vehicles are flying in a visible range of radio waves.

Furthermore, a virtual airway can be set in vertical and horizontal directions according to the present disclosure. Such airways can be used by flying vehicles in a manner similar to driving on a road.

While the present disclosure has been described above with respect to embodiments in conjunction with the accompanying drawings, the present disclosure is not limited thereto and should be interpreted to cover various modifications that will be apparent to those of ordinary skill in the art. The claims are intended to cover such modifications.

What is claimed is:

1. An airway setting device comprising:
front antennas disposed in a direction along an airway and each including at least two antennas spaced apart from each other to transmit radio frequency (RF) signals; and
a front wireless transmission circuit provided for each of the front antennas, and configured to encode transmission direction information based on a transmission axis of a corresponding front antenna, generate an RF signal separate from RF signal from an adjacent front antenna, and supply the generated RF signal to the corresponding front antenna.

2. The airway setting device of claim 1, wherein the at least two antennas of each of the front antennas comprise omni-directional transmission antennas, and
the front wireless transmission circuits sequentially supply an RF signal encoded with N pieces of transmission direction information to the front antennas in a set range based on the transmission axis.

3. The airway setting device of claim 1, further comprising a flight control unit configured to establish a session with a receiver whose measured transmission direction information and decoded transmission direction information match, and control an aerial vehicle equipped with the receiver through the session.

4. The airway setting device of claim 1, wherein each of the front antennas comprises:
a horizontal front antenna including at least two antennas disposed in a direction along the airway and spaced apart from each other in a direction parallel to a ground; and
a vertical front antenna provided with the same transmission axis as the horizontal front antenna and including at least two antennas spaced apart from each other in a direction perpendicular to the ground, and
each of the front wireless transmission circuits comprises:
a horizontal front wireless transmission circuit configured to encode transmission direction information in a direction parallel to the transmission axis, generate an RF signal separate from RF signals from an adjacent horizontal front antenna and an adjacent vertical front antenna, and supply the generated RF signal to a corresponding horizontal front antenna; and
a vertical front wireless transmission circuit configured to encode transmission direction information in a direction perpendicular to the transmission axis, generate an RF signal separate from RF signals from an adjacent horizontal front antenna and an adjacent vertical front antenna, and supply the generated RF signal to a corresponding vertical front antenna.

5. The airway setting device of claim 4, further comprising a flight control unit configured to establish a session with a receiver whose measured transmission direction information and decoded transmission direction information match, and control an aerial vehicle equipped with the receiver through the session.

6. The airway setting device of claim 5, wherein the flight control unit comprises a landing guidance unit configured to transmit transmission direction information about a virtual airway set as a landing site through the established session.

7. The airway setting device of claim 1, further comprising:
an antenna driver equipped with a front antenna and configured to rotate about a rotational axis; and
an airway controller configured to control the antenna driver to change a transmission direction of the front antenna.
